(19) United States
(12) Patent Application Publication
(10) Pub. No.: US 2022/0206283 A1
(43) Pub. Date: Jun. 30, 2022

(54) TELESCOPIC SIGHT HAVING TWO SIGHTING POINTS

(71) Applicant: SU Optics Co., Ltd., Changwon-si (KR)

(72) Inventors: Sang Ik LEE, Incheon (KR); KeeUk JEON, Seoul (KR)

(73) Assignee: SU Optics Co., Ltd., Changwon-si (KR)

(21) Appl. No.: 17/552,126

(22) Filed: Dec. 15, 2021

(30) Foreign Application Priority Data
Dec. 30, 2020 (KR) 10-2020-0187780

(51) Int. Cl. G02B 23/10; G02B 25/00; G02B 25/02

(52) U.S. Cl. CPC G02B 23/105; G02B 25/02; G02B 25/001

(57) ABSTRACT

Disclosed is a telescopic sight having two sighting points including an objective lens part which is provided in a telescopic sight body to reflect a light source beam irradiated from a light source part to a user's eye direction and transmitting an object beam and provided with a first focus part; a relay lens part which is provided in the telescopic sight body so as to be disposed between the objective lens part and the user's eye to erect and focus the light source beam and the object beam passing through the first focus part and provided with a second focus part; and an eyepiece lens part which is provided in the telescopic sight body as to be disposed between the relay lens part and the user's eye to eyepiece the light source beam and the object beam passing through the second focus part on the user's eye.

### CROSS-REFERENCE TO RELATED APPLICATIONS

This application claims the priority of Korean Patent Application No. 10-2020-0187780 filed on Dec. 30, 2020, in the Korean Intellectual Property Office, the disclosure of which is incorporated herein by reference.

### BACKGROUND OF THE INVENTION

### Field of the Invention

The present disclosure relates to a telescopic sight, and more particularly, to a telescopic sight having two sighting points capable of quickly adjusting a zero point with tow sighting points and easily identifying sighting points even in a day solar environment by providing clear red dots.

### Description of the Related Art

A telescopic sight may be referred to as a sighting optical device which sights a remote target object to allow a shot of a gun to hit the object, and a general telescopic sight optical device in which a plurality of lenses are appropriately disposed to implement a telescopic optical system, enlarge a remote object, and implement precise sighting for an enlarged object (target) using an embedded reticle pattern.

The telescopic sight optical device may be classified into a zoom lens optical system which may cause a change in a certain range of magnification by positioning some inner lenses in a predetermined period and a fixed magnification optical system which views the object by enlarging the object by only a single magnification without a change in magnification.

In the case of the existing general telescopic sight optical device, one reticle is mounted at any one of a first focus surface and a second focus surface to be used by only one sighting point (line), and thus, there is an inconvenience to perform at least three times shootings for zero point adjustment.

Further, in the existing telescopic sight optical device, for identification and ease of sighting, an illumination device is embedded in a reticle to implement a light emitting point at the center of the reticle. Mainly, there are techniques of a method of lightguiding LED light on a side surface of reticle glass to emit the light in an etching pattern of the glass center, a method of emitting light by inserting optical fiber into the reticle glass, and the like. In existing reticle light emitting technique, there is a disadvantage that it is difficult to implement the LED light brightly due to deterioration of light efficiency, and since the battery consumption is large to be bright, the battery life is shortened.

Therefore, in the day use, as an existing telescopic sight device, since it is not easy to implement a bright reticle to be suitable for a bright solar light environment, improvements thereof are required.

The above-described technical configuration is the background art for helping in the understanding of the present disclosure, and does not mean a conventional technology widely known in the art to which the present disclosure pertains.

### SUMMARY OF THE INVENTION

The present disclosure has been made in an effort to provide a telescopic sight having two sighting points consisting of an objective lens group including a reflective lens for LED light so as to enable precise sight shooting while solving the aforementioned disadvantages and inconvenience and being more easy and convenient.

According to an aspect of the present disclosure, there is provided a telescopic sight including: an objective lens part which is provided in a telescopic sight body to reflect a light source beam irradiated from a light source part to a user's eye direction and transmitting an object beam and provided with a first focus part; a relay lens part which is provided in the telescopic sight body so as to be disposed between the objective lens part and the user's eye to erect and focus the light source beam and the object beam passing through the first focus part and provided with a second focus part; and an eyepiece lens part which is provided in the telescopic sight body as to be disposed between the relay lens part and the user's eye to eyepiece the light source beam and the object beam passing through the second focus part on the user's eye.

A first sighting point formed by a pattern of a reticle located at any one of the first focus part and the second focus part and a second sighting point formed by the light source beam may be simultaneously included to implement two sighting points.

The objective lens part may include a first objective lens part which is provided in the telescopic sight body to reflect the light source beam irradiated from the light source part to the relay lens part and transmitting the object beam; and a second objective lens part which is provided in the telescopic sight body so as to be disposed between the first objective lens part and the relay lens part to focus the light source beam and the object beam passing through the first objective lens part to the first focus part.

The first objective lens part may be provided with a doublet lens in which a first concave lens and a first convex lens are conjugated with each other, and a light source member of the light source part may be located on both an edge of the doublet lens and an optical axis of the doublet lens.

The refractive power of the first objective lens part may be zero.

The relay lens part may include a condensing lens which is provided in the telescopic sight body between the first focus part and the second focus part to condense the light source beam and the object beam passing through the first focus part; a first erecting lens which is provided in the telescopic sight body to be disposed between the condensing lens and the eyepiece lens part to erect the light source beam and the object beam condensed in the condensing lens; and a second erecting lens which is provided in the telescopic sight body to be disposed between the first erecting lens and the eyepiece lens part to erect the light source beam and the object beam emitted from the first erecting lens and provided with the second focus part.

The condensing lens, the first erecting lens, and the second erecting lens may have positive refractive power.

The first erecting lens and the second erecting lens may move by a predetermined distance to generate a change in magnification.

The telescopic sight may further include at least one of a first zero point adjustment part which is provided in the telescopic sight body to adjust the position of the second sighting point; and a second zero point adjustment part which is provided in the telescopic sight body to adjust the position of the first sighting point.

The telescopic sight may further include a protective glass provided in the telescopic sight body so as to be disposed in front of the objective lens part.

The relay lens part may be replaced with a prism group capable of having an erecting image implementation function, only one focus part other than two focus parts of the first focus part and the second focus part may be included, the one focus part may be positioned between the prism group and the eyepiece lens part, and a reticle may be located in the one focus part, so that the first sighting point by the reticle pattern is provided, and the second sighting point formed by the light source beam is provided.

According to the embodiments of the present disclosure, it is possible to rapidly adjust a zero point by providing both a first sighting point by a reticle pattern on a first focus part or a second focus part and a second sighting point by an LED light source beam and easily identify a sighting point even in a day solar light environment by providing clear red dots.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram schematically illustrating a telescopic sight having two sighting points according to an embodiment of the present disclosure;

FIG. 2 is a cross-sectional view of FIG. 1;

FIG. 3 is a schematic front view of FIG. 1;

FIG. 4 is a diagram schematically illustrating a main configuration of the present embodiment;

FIG. 5 is a diagram schematically illustrating that a light source beam is reflected from a first objective lens part illustrated in FIG. 4;

FIG. 6 is a diagram schematically illustrating that an object beam is transmitted from the first objective lens part illustrated in FIG. 4;

FIG. 7 is an enlarged diagram illustrating an area of the first objective lens part illustrated in FIG. 5;

FIG. 8 is a diagram schematically illustrating a light path in which the object beam of the embodiment is implemented at 4× magnifications;

FIG. 9 is a diagram schematically illustrating a light path in which alight source beam irradiated from a light source member of the embodiment is reflected from the first objective lens part and directed;

FIG. 10 is a diagram illustrating that the object beam and the light source beam illustrated in FIGS. 8 and 9 are synthesized;

FIG. 11 is a diagram illustrating a main sighting line implemented by the embodiment and two sighting points of a main sighting point and a sub sighting point at central points of the main sighting line in a clock circle;

FIG. 12 is a diagram illustrating on and off states of the sub sighting point illustrated in FIG. 11;

FIG. 13 is a diagram illustrating a process for a method for adjusting a zero (0) point by single shooting of the embodiment by steps; and

FIG. 14 is a diagram schematically illustrating a telescopic sight according to another embodiment of the present disclosure.

### DETAILED DESCRIPTION OF THE PREFERRED EMBODIMENT

In order to fully understand the present disclosure, operational advantages of the present disclosure and objects to be achieved by implementing the present disclosure, the present disclosure will be described with reference to the accompanying drawings which illustrate preferred embodiments of the present disclosure and the contents illustrated in the accompanying drawings.

Hereinafter, preferred embodiments of the present disclosure will be described in detail with reference to the accompanying drawings. Like reference numerals illustrated in the respective drawings designate like members.

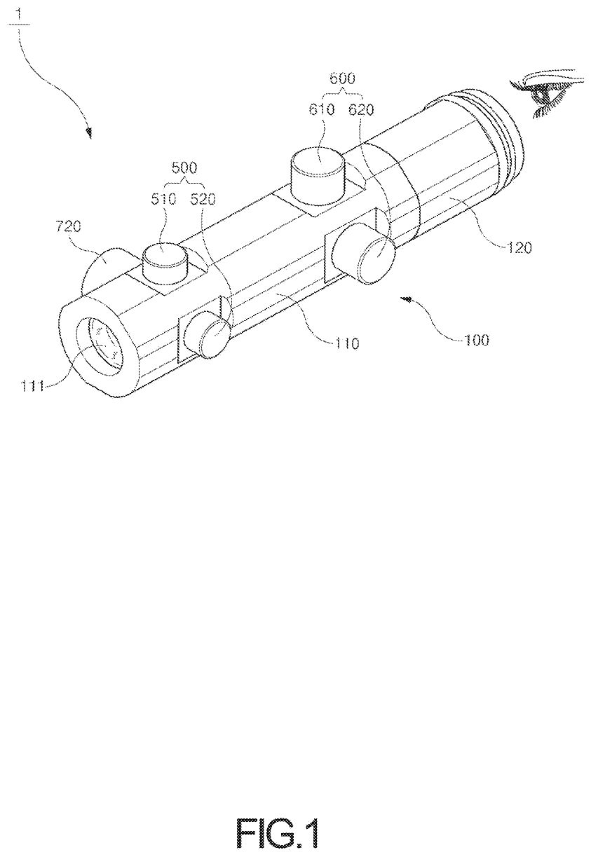

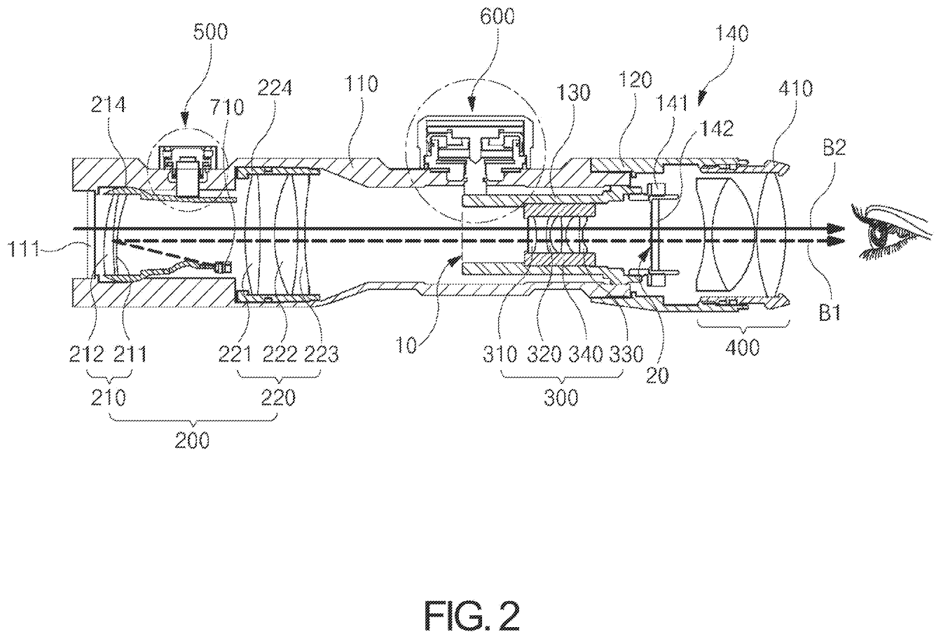

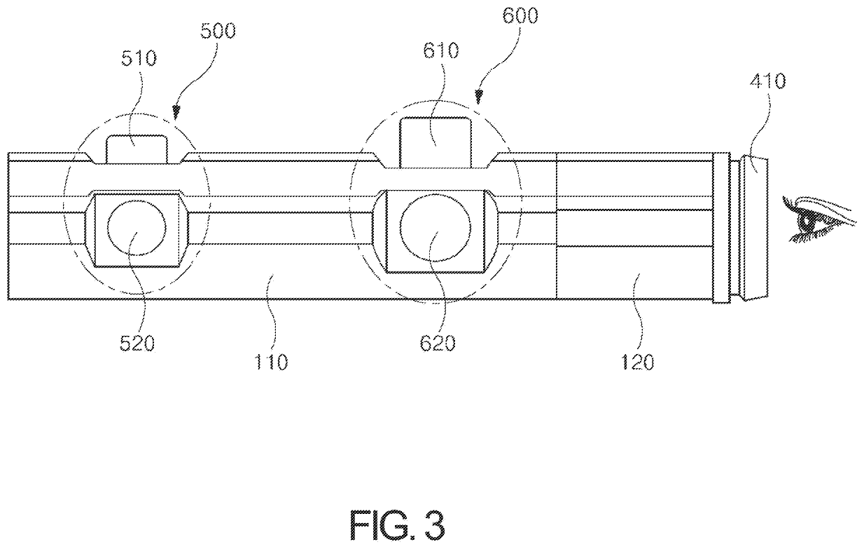

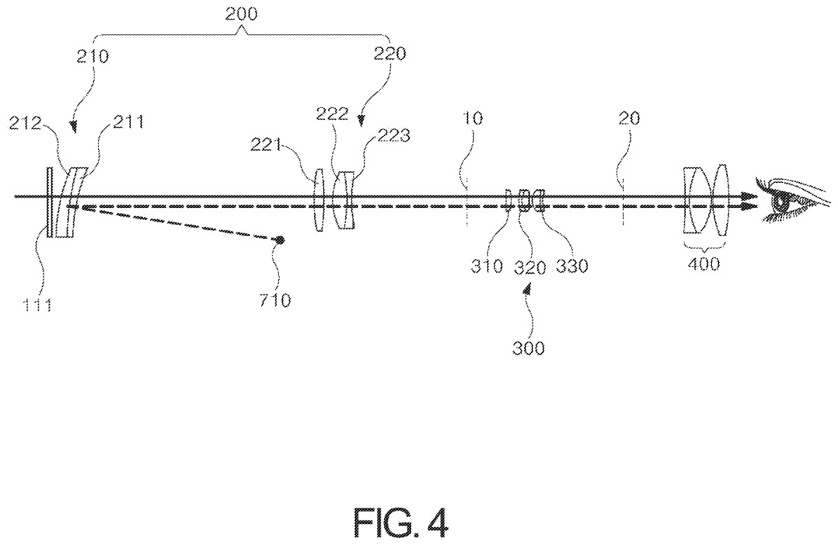

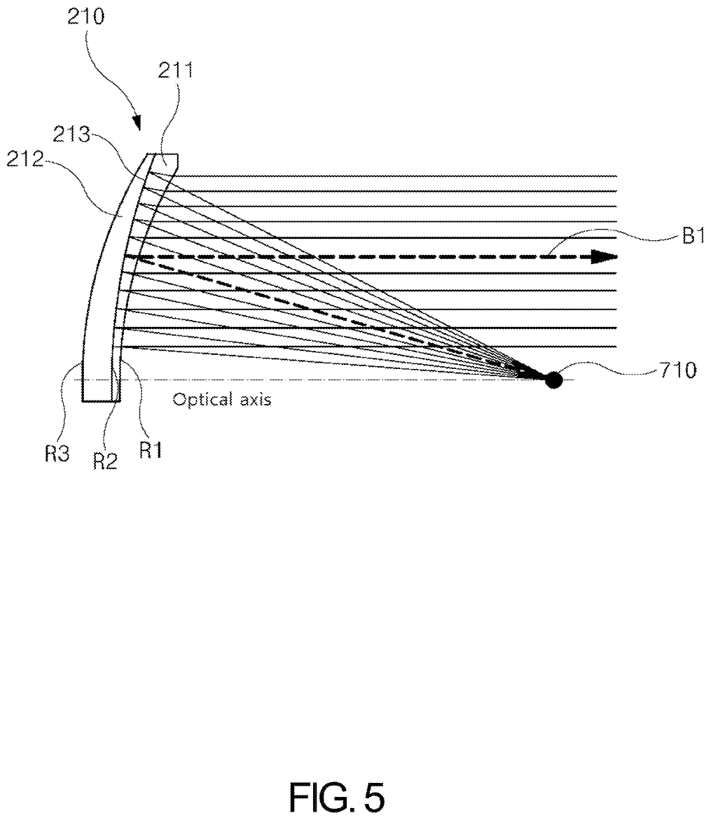

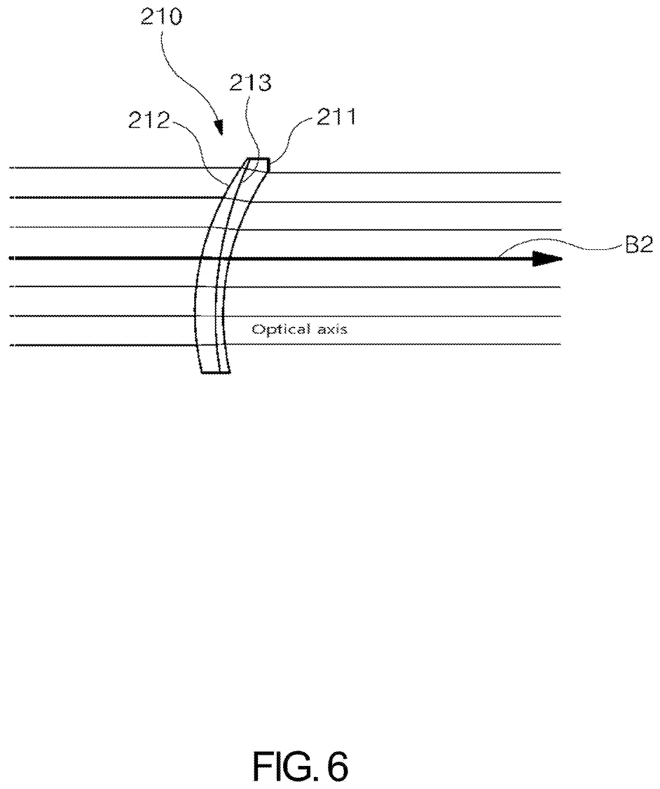

FIG. 1 is a diagram schematically illustrating a telescopic sight having two sighting points according to an embodiment of the present disclosure, FIG. 2 is a cross-sectional view of FIG. 1, FIG. 3 is a schematic front view of FIG. 1, FIG. 4 is a diagram schematically illustrating a main configuration of the present embodiment, FIG. 5 is a diagram schematically illustrating that a light source beam is reflected from a first objective lens part illustrated in FIG. 4, and FIG. 6 is a diagram schematically illustrating that an object beam is transmitted from the first objective lens part illustrated in FIG. 4.

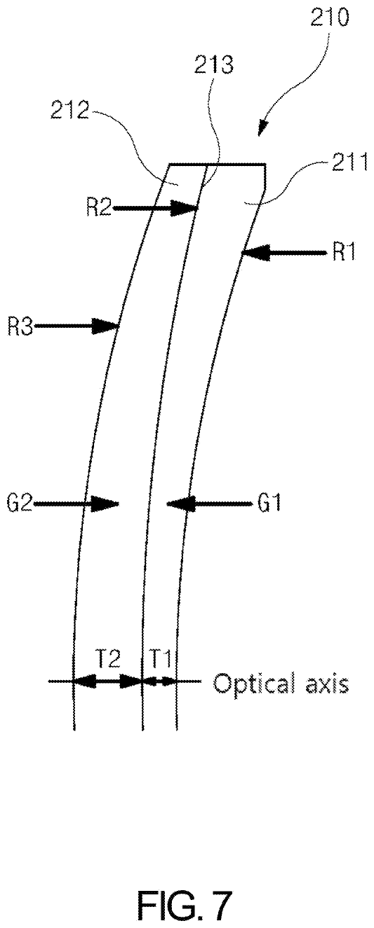

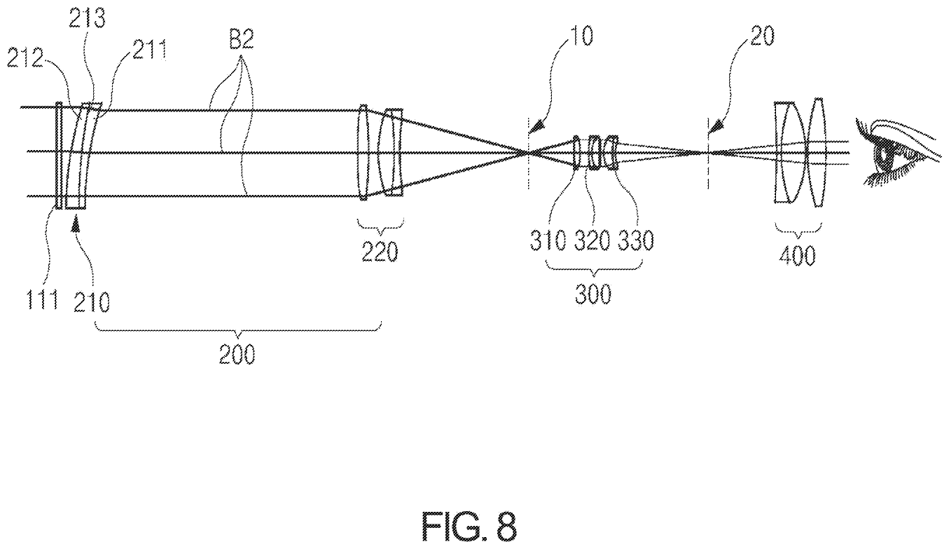

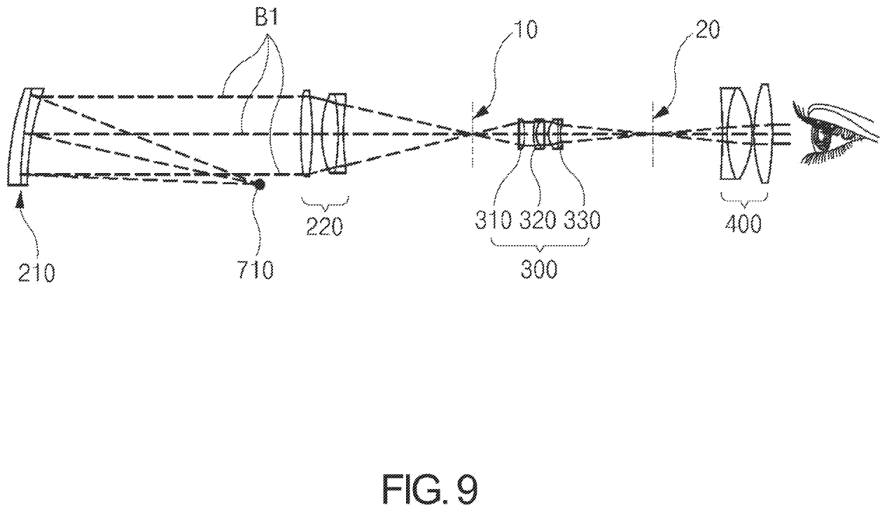

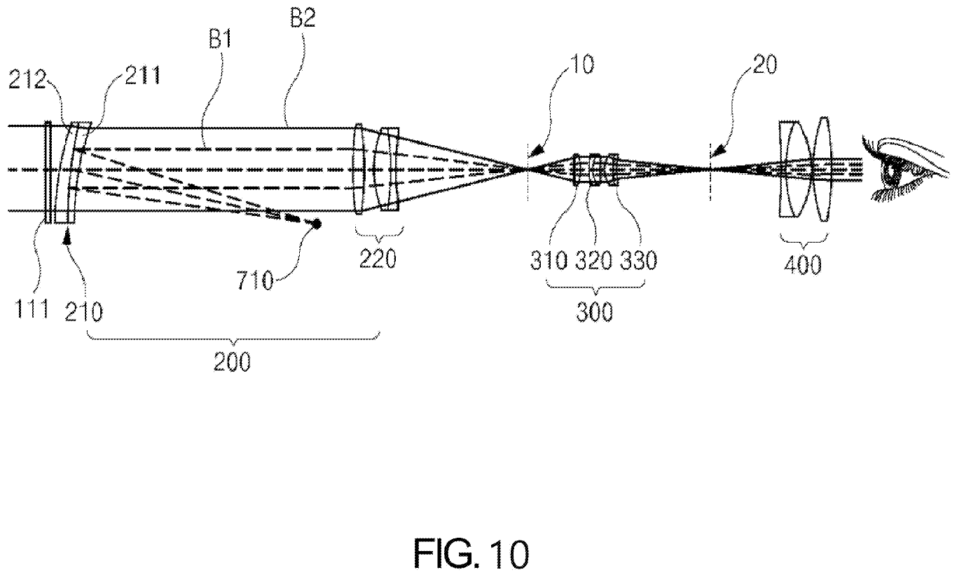

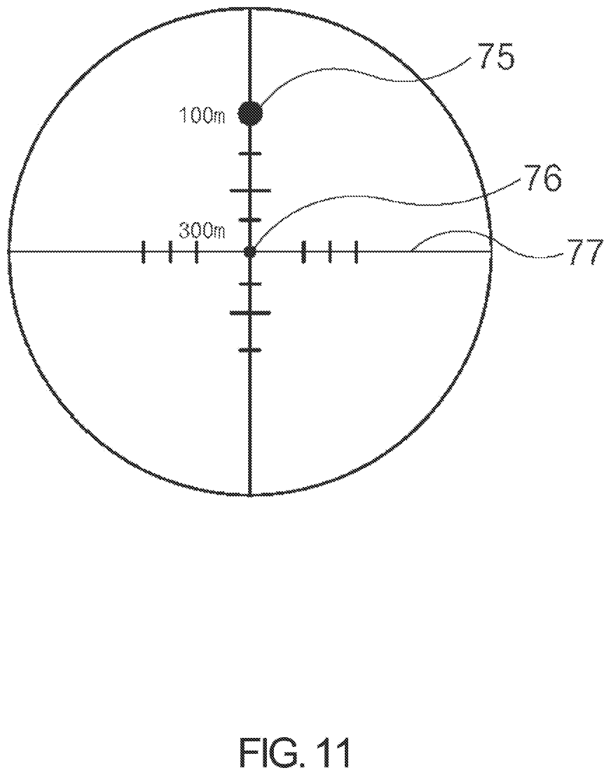

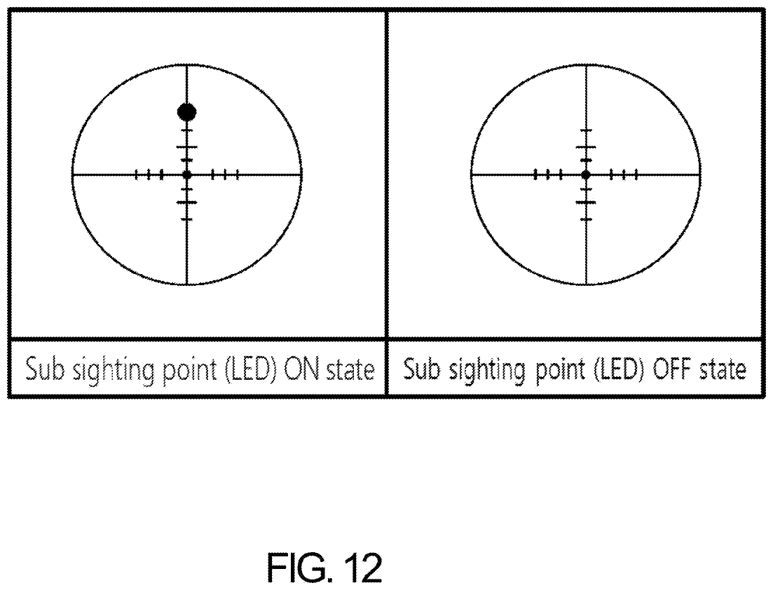

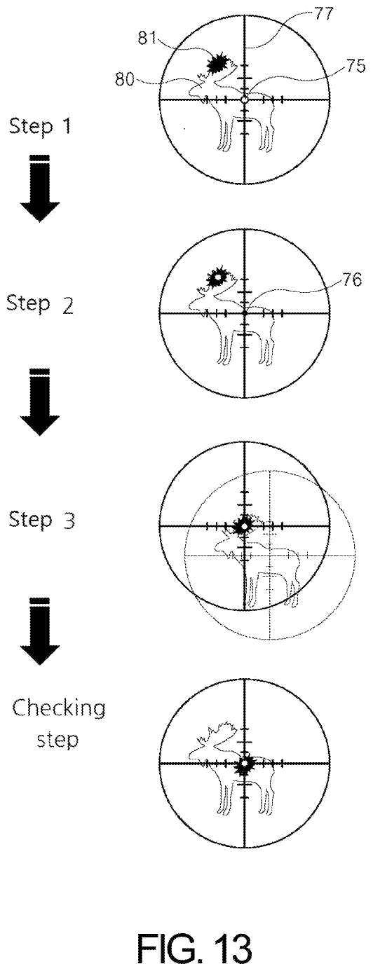

In addition, FIG. 7 is an enlarged diagram illustrating an area of the first objective lens part illustrated in FIG. 5, FIG. 8 is a diagram schematically illustrating a light path in which the object beam of the embodiment is implemented at 4× magnifications, FIG. 9 is a diagram schematically illustrating a light path in which a light source beam irradiated from a light source member of the embodiment is reflected from the first objective lens part and directed, FIG. 10 is a diagram illustrating that the object beam and the light source beam illustrated in FIGS. 8 and 9 are synthesized, FIG. 11 is a diagram illustrating a main sighting line implemented by the embodiment and two sighting points of a main sighting point and a sub sighting point at central points of the main sighting line in a clock circle, FIG. 12 is a diagram illustrating on and off states of the sub sighting point illustrated in FIG. 11, and FIG. 13 is a diagram illustrating a process for a method for adjusting a zero (0) point by single shooting of the embodiment by steps.

As illustrated in these drawings, a telescopic sight 1 having two sighting points according to the embodiment includes an objective lens part 200 which is provided in a telescopic sight body 100 to reflect alight source beam B1 irradiated from a light source part 700 to a user's eye direction and transmitting an object beam B2 and provided with a first focus part 10, a relay lens part 300 which is provided in the telescopic sight body 100 so as to be disposed between the objective lens part 200 and the user's eye to erect and focus the light source beam B1 and the object beam B2 passing through the first focus part 10 and provided with a second focus part 20, an eyepiece lens part 400 which is provided in the telescopic sight body 100 so as to be disposed between the relay lens part 300 and the user's eye to eyepiece the light source beam B1 and the object beam B2 passing through the second focus part 20 on the user's eye, a first zero point adjustment part 500 provided in the telescopic sight body 100 to adjust the position of a second sighting point or a sub sighting point, a second zero point adjustment part 600 provided in the telescopic sight body 100 to adjust the position of a first sighting point or a main sighting point, and a light source part 700 irradiating the light source beam B1 to the objective lens part 200.

The telescopic sight body 100, as illustrated in FIG. 2, includes a base body 110, an eyepiece body 120 detachably coupled to the rear side of the base body 110, an inner body 130 coupled to the inside of the base body 110 to support the relay lens part 300, and a reticle part 140 provided in the eyepiece body 120 and positioned in the second focus part 20 to be used as the main sighting point or the main sighting line.

In the base body 110 of the telescopic sight body 100, as illustrated in FIG. 2, the objective lens part 200, the first zero point adjustment part 500, and the light source part 700 are provided in the front side, and the relay lens part 300 and the second zero point adjustment part 600 may be provided in the rear side.

In the eyepiece body 120 of the telescopic sight body 100, as illustrated in FIG. 2, the eyepiece lens part 400 may be provided.

The inner body 130 of the telescopic sight body 100, as illustrated in FIG. 2, is provided in the rear side of the base body 110 and the relay lens part 300 may be provided therein.

In the embodiment, the second zero point adjustment part 600 presses the front upper portion of the inner body 130 to generate a change in angle for a third housing 340 and the relay lens part 300 as the inner body 130 is inclined by the hinge structure and the spring force of the inner body 130.

The embodiment includes a first focus surface portion on which the light source beam B1 and the object beam B2 from the objective lens part 200 are first imaged and a second focus surface portion on which the light source beam B1 and the object beam B2 from the relay lens part 300 are second imaged. A glass etching or a wire reticle is mounted on any one of the first focus part 10 and the second focus part 20 to be used as the main sighting line or the main sighting point of the center point of the reticle pattern.

As illustrated in FIG. 2, the objective lens part 200 is provided with a first objective lens part 210 and a second objective lens part 220, and a transparent protective glass 111 without refraction power is mounted in front of the first objective lens part 210 to prevent scratches and the like by foreign matters, dust, scratch, and the like.

The light source beam B1 emitted from the light source member 710 of the light source part 700 is reflected in a lens reflection part 213 which is a junction surface of a doublet lens of the first objective lens part 210 to be incident to the second objective lens part 220. The objective beam B2 from the object passes through the protective glass 111 and the first objective lens part 210 and then is incident to the second objective lens part 220 and commonly passes through subsequent lenses to see both the light source beam B1 and the object beam through the final eyepiece lens part 400 with eyes.

The first objective lens part 210 may also use a single lens other than the doublet lens, and in this case, a method of reflecting the light source beam B1 on any surface of front and rear surfaces of the single lens may be applied.

The object beam B2 passes through the objective lens part 200 and then first focused or imaged on the first focus part 10 to be incident to the relay lens part 300, and passes a condensing lens 310 condensing the beam and a first erecting lens 320 and a second erecting lens 330 for erecting the image to be second focused on the second focus part 20.

The second focused light source beam B1 and object beam B2 form a final image on the retina of the eye by the eyepiece lens part 400.

A reticle engraved with the glass etching or wire-shaped pattern may be positioned at any one of the first focus part 10 and the second focus part 20.

The relay lens part 300 may be configured differently from the embodiment of the present disclosure and configured by two sheets or more of single lenses or doublet lenses, and the first lens may be referred to as the condensing lens 310 and the remaining lenses may be referred to as the erecting lenses, and both lenses may have plus power.

Table 1 illustrates lens design data for the telescopic sight optical system and may be referred to as a telescopic sight lens optical system capable of implementing 4× magnification as a fixed magnification and implementing a composite function of a main sighting line or sighting point by the reticle of the first focus part 10 or the second focus part 20 and a sub sighting line or sub sighting point by the LED light of the light source member 710.

TABLE 1

| Lens classification | | | Curvature | Thickness | Effective | | |
|---|---|---|---|---|---|---|---|
| (reference numerals | | Surface | radius | or interval | radius | Refractive | Spreading |
| of FIG. 2) | | No. | (mm) | (mm) | (mm) | index | coefficient |
| Object surface | | 0 | ∞ | ∞ | | | |
| Protective glass | | 1 | ∞ | 2 | 15.0 | 1.51680 | 64.20 |
| (111) | | 2 | ∞ | 2 | 15.0 | | |
| Objective | First | 3 | 100.48 | 5 | 15.0 | 1.51680 | 64.20 |
| lens | objective | 4 | 145.86 | 2.5 | 15.0 | 1.51680 | 64.20 |
| part | lens part | 5 | 970.90 | 110 | 15.0 | | |
| (200) | (210) | | | | | | |
| | Second | 6 | 81.00 | 4.5 | 15.0 | 1.71300 | 53.94 |
| | objective | 7 | −131.00 | 4 | 14.9 | | |
| | lens part | 8 | 37.00 | 6.50 | 13.6 | 1.48749 | 70.45 |
| | (220) | 9 | −92.00 | 2.00 | 14.6 | 1.80610 | 33.27 |
| | | 10 | 75.00 | 51.70 | 12.2 | | |
| First focus part (10) | | 11 | ∞ | 19.00 | 3.0 | | |
| Relay | Condensing | ∞ | ∞ | 2.50 | 4.6 | 1.71300 | 53.94 |
| lens | lens | 13 | −16.30 | 3.30 | 4.8 | | |
| part | (310) | | | | | | |
| (300) | First | 14 | 17.40 | 1.10 | 4.8 | 1.84666 | 23.78 |
| | erecting | 15 | 7.90 | 3.40 | 5.5 | 1.48749 | 70.45 |
| | lens | 16 | −145.00 | 1.50 | 4.6 | | |
| | (320) | | | | | | |
| | Second | 17 | 8.30 | 3.60 | 4.6 | 1.74400 | 44.90 |
| | erecting | 18 | 25.30 | 1.10 | 5.5 | 1.80518 | 25.46 |
| | lens | 19 | 8.200 | 37.00 | 3.7 | | |
| | (330) | | | | | | |

| | | | | | | |
|---|---|---|---|---|---|---|
| Second focus part (20) | 20 | ∞ | 28.20 | 7.3 | | |
| Eyepiece lens part | 21 | −137.00 | 2.000 | 13.8 | 1.80518 | 25.46 |
| (400) | 22 | 43.00 | 10.00 | 16.8 | 1.48749 | 70.45 |
| | 23 | −31.00 | 0.50 | 15.8 | | |
| | 24 | 51.00 | 7.500 | 17.3 | 1.67003 | 47.19 |
| | 25 | −105.00 | 93.34 | 17.3 | | |

| | |
|---|---|
| Moving lens of center of curvature | First objective lens part |
| Moving surface of center of curvature | 3, 4, 5 faces |
| Moving amount of (Y directional) center of | −18.8 mm (Lower direction) |
| curvature | |

As a partial device of the objective lens part 200 for implementing the embodiment, a basic schematic diagram for an LED light reflective lens as the first objective lens part 210 is illustrated in FIGS. 5 and 6.

In the embodiment, as illustrated in FIG. 5, the first objective lens part 210 is used as a doublet lens consisting of a first concave lens 211 and a first convex lens 212, and alight source member 710 applied with an LED device is disposed at an optical axis of the doublet lens and disposed at a focal position of the first concave lens 211 serving to reflect the LED light.

The light source member 710 usually uses a lot of red light corresponding to about 650 nm, but is also used as a light source of green light of about 520 nm and other visible wavelength regions.

The light source beam B1 emitted from the light source member 710 disposed at the focal position of the first concave lens 211 is reflected from a lens reflection surface (R2 surface) and then becomes to a collimated beam to be vertically incident to the second objective lens part 220, and is input to an observer's eye through the telescopic sight optical system to be recognized as a red dot which is a sub sighting point. Various linear patterns may be input to a peripheral portion including a circular dot of the light source member 710 and in this case, may be referred to as a sub sighting line including the sub sighting point. In the embodiment, as illustrated in FIG. 4, the second objective lens part 220 includes a lens member 221 disposed between the first objective lens part 210 and the relay lens part 300, and a second convex lens 222 and a second concave lens 223 spaced part from each other at the rear side of the lens member 221 and conjugated to each other.

Further, as illustrated in FIG. 6, the object beam B2 incident from the object may pass through the first objective lens part 210 at 1× magnification, and for the 1× magnification, the lenses need to be configured so that the refractive power of the doublet lens as the first objective lens part 210 becomes zero (0) and even if the beam passes through the lens, the beam state and the magnification should not vary like a case without the lens.

Therefore, if the collimated beam of the object beam B2 is incident to the first objective lens part 210 and then passes through the first objective lens part 210, the emitted beam needs to be a collimated beam.

As illustrated in FIG. 5, an appropriate lens design needs to be made so that the light source beam B1 emitted from the light source member 710 is reflected from the first concave lens 211 to be emitted in parallel, and as illustrated in FIG. 6, the object beam B2 started from the object is incident to the first objective lens part and then emitted in parallel. The lenses need be disposed so that the light source beam B1 and the object beam B2 are synthesized and simultaneously, vertically incident to the second objective lens part 220.

In order to design the doublet lens of the first objective lens part 210 having the function described above, it is implemented by appropriately optimizing design variables such as a curvature and a thickness of the lens, a refractive index of a glass material, and the like, and a design example of the doublet lens having the function described above is illustrated in FIG. 7.

In FIG. 7, since the first concave lens 211 (G1 lens) of the doublet lens was applied with a focal length EFL f=95 mm and designed so that the power of the conjugated entire lens is zero and the focal length is almost infinite (not focused), an LED light reflective optical system of viewing an image of the object at 1× magnification may be implemented and a 1× clear image having a minimized time difference for the LED reflective light and minimized aberration for the object may be implemented. The following Table 2 illustrates curvatures R1, R2, and R3, thicknesses T1 and T2, and materials G1 and G2 illustrated in FIG. 7. Here, BK7 has a refractive index (n) of 1.5168, and an Abbe's number (v) of 64.2.

TABLE 2

| Item | | Specification | |
|---|---|---|---|
| Curvature | R1 | 97.901 | mm |
| | R2 | 145.861 | mm |
| | R3 | 100.477 | mm |
| Thickness | T1 | 2.5 | mm |
| | T2 | 5.0 | mm |

| | | |
|---|---|---|
| Material | G1 | BK7 |
| | G2 | BK7 |

The first objective lens part 210 as the reflective lens of the LED light reflective optical system designed as above is provided at a position appropriately spaced apart from a front end of the second objective lens part 220 to be a composite objective lens part 200 combined with the first objective lens part 210 and the second objective lens part 220. The composite objective lens part 200 may be illustrated in a layout diagram of FIGS. 8 and 9 and a telescopic sight optical system having two sighting points of the embodiment may be implemented.

FIG. 8 illustrates a light path diagram in which the object beam B2 is implemented at 4× magnifications, FIG. 9 illustrates a light path diagram in which the light source beam B1 is reflected and directed, and FIG. 10 illustrates a light path diagram in which the object beam B2 and the light source beam B1 are synthesized by transmission and reflection to and from the first objective lens part 210 to be simultaneously directed.

In FIG. 8, while the object beam B2 corresponding to the incident light from the object passes through the first objective lens part 210 as the doublet lens and then passes through the remaining telescopic sight optical system, an image of the erected object may be seen like a telescope.

In the telescopic sight optical system of FIG. 8, since the first objective lens part 210 has a 1× magnification having power of zero, the telescopic sight optical system may be maintained the same as the magnification of the remaining telescopic sight optical system except for the first objective lens part.

Further, since the first objective lens part 210 becomes an off-axis system lateral-moved or de-centered by a predetermined amount as compared with the optical axis of the remaining telescopic sight optical system, it may be expected to deteriorate the performance of the image for the object, but since the refractive power of the first objective lens part 210 is zero, an effect on the image performance of the telescopic sight optical system is slight to maintain the original image performance well.

FIG. 9 illustrates a light path diagram for the light source beam B1. The light source beam B1 emitted from the light source member 710 is reflected from the junction surface (R2 surface) of the first objective lens part 210 and then incident to the second objective lens part 220 and passes through the remaining lenses to be recognized as a red dot as the sub sighting point.

At this time, the first objective lens part 210 needs to be disposed so that the light source beam B1 (main light) of the light source member 710 reflected from the first objective lens part 210 is vertically incident to the second objective lens part 220.

A reflective coating capable of reflecting only a specific wavelength range is deposited on the junction surface of the first objective lens part 210, and when LED light having a main wavelength range of 650 nm is applied, the coating characteristic of the junction surface is applied by reflecting only a wavelength range of about 650 nm and transmitting the entire remaining visible light area.

Therefore, as illustrated in FIG. 9, the light source beam B1 having a main wavelength range of 650 nm is reflected from the junction surface of the first objective lens part 210 and passes through the first concave lens 211 again to be incident to the second objective lens part 220. The visible light which is the object light started from the object passes through first concave lens 211 except for only a wavelength range of about 650 nm in the first objective lens part 210 of FIG. 8, and then is incident to the second objective lens part 220, and as a result, as illustrated in FIG. 10, the light source beam B1 and the object beam B2 are synthesized.

Since the synthesized light source beam B1 and object beam B2 is overlapped to pass through the remaining telescopic sight optical system, the red dot of the LED light as the sub sighting point may be overlapped at the position of the object as a target. The red dot becomes a main means capable of easily using two sighting points as an implementation target of the embodiment in addition to the main sighting point which is the center point of the reticle pattern located at any one of the first focus part 10 and the second focus part 20.

FIG. 2 is a schematic cross-sectional view of the embodiment and includes the first zero point adjustment part 500 adjusting the zero point of the second sighting point and the second zero point adjustment part 600 adjusting the zero point of the first sighting point.

A reticle member 142 to be used as the main sighting point or main sighting line of the embodiment is located in the second focus part 20 and may be used to be located at the first focus part 10.

A first housing 214, a second housing 224, the inner body 130, and the like are inserted into the base body 110 covering the optical system and the inner structures, connected and assembled with the eyepiece body 120, and connected with the first zero point adjustment part 500 and the second zero point adjustment part 600.

A third housing 340 is inserted into the inner body 130 and connected with a reticle housing 141.

A part of the first zero point adjustment part 500 may be inserted to the base body 110 in a spiral form, and when a click dial which is a handle of the first zero point adjustment part 500 turns, one side of the first housing 214 is pressed or released by vertical or horizontal movement and a change in angle for the first objective lens part 210 occurs by the hinge structure and the spring force of the first housing 214. Accordingly, an oriented angle of the light source beam B1 for the LED light varies to enable the positioning of the red dot which is the sub sighting point.

Similarly, apart of the second zero point adjustment part 600 may be inserted to the base body 110 in a spiral form, and when a click dial which is a handle of the second zero point adjustment part 600 turns, one side of the inner body 130 is pressed or released by vertical or horizontal movement and the inner body 130 is inclined by the hinge structure and the spring force of the inner body 130, so that a change in angle for the third housing 340 and the relay lens part 300 occurs.

Accordingly, the oriented angle for the object beam B2 which is incident through the objective lens part 200 and refracted and transmitted through the relay lens part 300 varies to enable the positioning of the main sighting point and the main sighting line.

The second housing 224 may be fixed and inserted to the base body 110, but for focusing adjustment for a long distance of the object or target position, a front and rear positioning structure of the second housing 224 may be applied, and an adjustment method of a rotational movement by a screw method or a linear movement by a groove structure, and the like may be applied.

A screw method and the like are applied to enable the front and rear positioning of a fourth housing 410 inserted to the eyepiece body 120, so that a clear image may be recognized by diopter adjustment to fit the diopter of the human's eyes.

FIGS. 1 and 3 illustrate an appearance shape of the result of implementing the inner structure of FIG. 2, wherein FIG. 3 illustrates an external design side view and FIG. 1 illustrates a perspective view.

In FIGS. 1 and 3, a first vertical zero point adjuster 510 and a first horizontal zero point adjuster 520 of the first zero point adjustment part 500 are inserted to the base body 110 so as to position the sub sighting point of the red dot of the LED light, and the sub sighting point may be freely positioned vertically and horizontally using the first vertical zero point adjuster 510 and the first horizontal zero point adjuster 520.

Further, a second vertical zero point adjuster 610 and a second horizontal zero point adjuster 620 of the second zero point adjustment part 600 are inserted to the base body 110, and the main sighting point may be freely positioned vertically and horizontally using the second vertical zero point adjuster 610 and the second horizontal zero point adjuster 620.

The brightness of the red dot of the sub sighting point may be adjusted using a light source brightness adjustment member 720 illustrated in FIG. 1, and the diopter may be adjusted according to the front and rear positioning of the fourth housing 410 in the eyepiece body 120 connected to the base body 110.

A transparent protective glass 111 with no refractive force (power) and high transmittance is mounted at a telescopic sight entrance to which the object beam B2 is incident to prevent scratches by foreign matters, dust, and scratch from the outside.

FIG. 11 illustrates that a main sighting line 77 and two sighting points of a main sighting point 76 and a sub sighting point 75 which are center points of the main sighting line 77 technically implemented in the telescopic sight optical system having the two sighting points described above are represented in a clock circle. There is provided convenience, such as using the main sighting point 76 for a long distance of about 300 m and using the sub sighting point 75 for a short distance of about 100 m.

In addition, like the left diagram of FIG. 12, the two sighting points may be simultaneously used, but like the right diagram, the LED light source of the sub sighting point for the short distance is turned off to use only the main sighting point or main sighting line for the long distance in the same manner as a general telescopic sight.

In addition, it is convenient and preferred that precise shooting for a long-range target uses the main sighting point and rapid shooting for a short-range object uses the sub sighting point using the reflective optical system.

FIG. 13 illustrates a process for a method for adjusting a zero (0) point by single shooting as one of main targets of the embodiment by steps and the zero point adjustment may be performed in the following sequence.

Step 1: While the main sighting point 76 which is a cross pattern center of the main sighting line 77 of the reticle and the sub sighting point 75 in the red dot form match each other, the shooting is performed by sighting the target 80 and then the position of a spot 81 is checked.

Step 2: While the main sighting point 76 firmly and continuously coincides with an original target point of the sighting target 80, the first vertical zero point adjuster 510 and the first horizontal zero point adjuster 520 illustrated in FIGS. 1 and 3 for adjusting the vertical/horizontal direction of the sub sighting point 75 are appropriately rotated to match the red dot of the sub sighting point 75 with the position of the spot 81. It is noted that when the red dot as the sub sighting point 75 coincides with the spot 81, the center point of the reticle cross pattern as the main sighting point 76 needs to coincide with the target point of the original target object, and readjusted if mismatched, so that the two sighting points are accurately matched with the spot and the target point.

Step 3: When the spot 81 and the red dot of the sub sighting point 75 are simultaneously pulled and matched with the reticle cross pattern center of the main sighting point 76 by adjusting the image position using the second vertical zero point adjuster 610 and the second horizontal zero point adjuster 620, the zero point adjustment is completed.

Checking step: While the zero point adjustment is completed in sequence of the process of steps 1 to 3 described above, the target object is re-sighted and the shooting is performed.

When the verification shooting of the checking step is performed after the zero point adjustment including once shooting of steps 1 to 3 described above, the target object is hit to enable the zero point adjustment by single shooting.

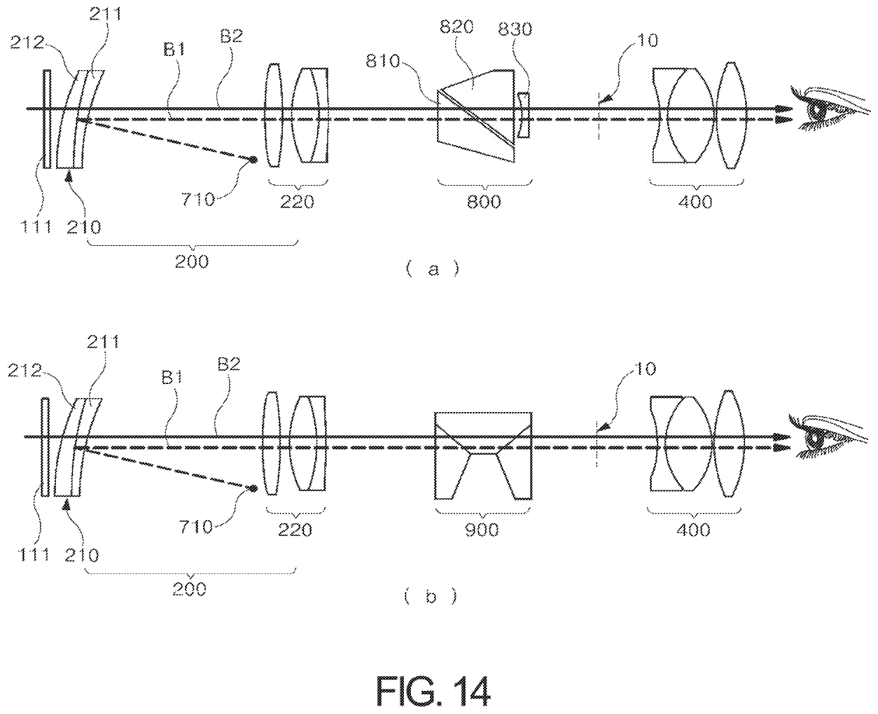

The upper diagram of FIG. 14 is another embodiment of the present disclosure and may be replaced with a prism having a function of implementing an erecting image of the relay lens part 300, and may be a Shmidt-Pechan prism type as an applicable prism form, and may be used by combining a Pechan prism 810 and a Shmidt Roof prism 820 as illustrated in FIG. 14A.

Further, an optical system may be designed with a structure used or not used by inserting a concave lens type of auxiliary lens 830 for improving the optical performance to a position appropriately spaced apart from a prism emitting surface.

When the Pechan prism 810, the Shmidt Roof prism 820, and the auxiliary lens 830 are included to be a first prism group 800, the first prism group 800 may replace an erecting image function of the relay lens part 300.

The prism type telescopic sight optical system described above has only a focus part as the first focus part 10 without having two focus parts such as the first focus part 10 and the second focus part 20, and may be an optical system in which one focus part is located between the first prism group 800 and the eyepiece lens part 400 and the reticle is located in one focus part to implement the main sighting line or main sighting point by the reticle pattern.

The remaining sub sighting line or sub sighting point is a structure implemented by an LED light source and an LED reflective lens in the doublet lens form as the part of the objective lens part 200 in the same manner as the telescopic sight optical system applied with the relay lens part 300.

Meanwhile, other prism forms other than the Shmidt-Pechan prism type may be applied, and the erecting image function is enabled by applying a ‘ [symbol] ’-shaped Uppendahl prism 900 type as illustrated in FIG. 14B to implement the telescopic sight optical system of the present disclosure.

As described above, the present disclosure is not limited to the embodiments described herein, and it will be apparent to those skilled in the art that various changes and modifications may be made without departing from the spirit and the scope of the present disclosure. Therefore, it will be understood that these changes and modifications are included in the appended claims of the present disclosure.

What is claimed is:

1. A telescopic sight comprising:
an objective lens part which is provided in a telescopic sight body to reflect a light source beam irradiated from a light source part to a user's eye direction and transmitting an object beam and provided with a first focus part;
a relay lens part which is provided in the telescopic sight body so as to be disposed between the objective lens part and the user's eye to erect and focus the light source beam and the object beam passing through the first focus part and provided with a second focus part; and
an eyepiece lens part which is provided in the telescopic sight body as to be disposed between the relay lens part and the user's eye to eyepiece the light source beam and the object beam passing through the second focus part on the user's eye.

2. The telescopic sight of claim 1, wherein a first sighting point formed by a pattern of a reticle located at any one of the first focus part and the second focus part and a second sighting point formed by the light source beam are simultaneously included to provide two sighting points.

3. The telescopic sight of claim 1, wherein the objective lens part comprises
a first objective lens part which is provided in the telescopic sight body to reflect the light source beam irradiated from the light source part to the relay lens part and transmitting the object beam; and
a second objective lens part which is provided in the telescopic sight body so as to be disposed between the first objective lens part and the relay lens part to focus the light source beam and the object beam passing through the first objective lens part to the first focus part.

4. The telescopic sight of claim 3, wherein the first objective lens part is provided with a doublet lens in which a first concave lens and a first convex lens are conjugated with each other, and
a light source member of the light source part is located on both an edge of the doublet lens and an optical axis of the doublet lens.

5. The telescopic sight of claim 3, wherein the refractive power of the first objective lens part is zero.

6. The telescopic sight of claim 1, wherein the relay lens part comprises:
a condensing lens which is provided in the telescopic sight body between the first focus part and the second focus part to condense the light source beam and the object beam passing through the first focus part;
a first erecting lens which is provided in the telescopic sight body to be disposed between the condensing lens and the eyepiece lens part to erect the light source beam and the object beam condensed in the condensing lens; and
a second erecting lens which is provided in the telescopic sight body to be disposed between the first erecting lens and the eyepiece lens part to erect the light source beam and the object beam emitted from the first erecting lens and provided with the second focus part.

7. The telescopic sight of claim 6, wherein the condensing lens, the first erecting lens, and the second erecting lens have positive refractive power.

8. The telescopic sight of claim 6, wherein the first erecting lens and the second erecting lens move by a predetermined distance to generate a change in magnification.

9. The telescopic sight of claim 1, further comprising: at least one of
a first zero point adjustment part which is provided in the telescopic sight body to adjust the position of the second sighting point; and
a second zero point adjustment part which is provided in the telescopic sight body to adjust the position of the first sighting point.

10. The telescopic sight of claim 1, further comprising:
a protective glass provided in the telescopic sight body so as to be disposed in front of the objective lens part.

11. The telescopic sight of claim 1, wherein the relay lens part is replaced with a prism group capable of having an erecting image implementation function,
only one focus part other than two focus parts of the first focus part and the second focus part is included,
the one focus part is positioned between the prism group and the eyepiece lens part and a reticle is located in the one focus part, so that the first sighting point by the reticle pattern is provided, and
the second sighting point formed by the light source beam is provided.
